(19) United States
(12) Patent Application Publication
(10) Pub. No.: US 2015/0037447 A1
(43) Pub. Date: Feb. 5, 2015

(54) EXTRUDER

(71) Applicant: LEISTRITZ EXTRUSIONSTECHNIK GMBH, Nurnberg (DE)

(72) Inventors: Frank Rechter, Uffenheim OT Welbhausen (DE); Sven Wolf, Oberasbach (DE)

(21) Appl. No.: 14/449,791

(22) Filed: Aug. 1, 2014

(30) Foreign Application Priority Data
Aug. 2, 2013 (DE) 10 2013 108 335.8

(51) Int. Cl. B29C 47/08

(52) U.S. Cl. CPC B29C 47/0825; B29C 47/0818
USPC 425/135

(57) ABSTRACT

An extruder having an operative unit having a cylinder and at least one extruder screw which is removably accommodated therein, a motor and a gear unit which is separated from the motor via a clutch and which drives the extruder screw, wherein the extruder screw is releasably connected to the gear unit, and a controller installation which controls the operation of the motor or at least of a further installation which is provided. The operative unit or is assigned to the operative unit, wherein at least one information element which identifies the extruder screw and which, during or after insertion of the extruder screw into the cylinder or connection to the gear unit, is automatically acquirable by a sensor element, is provided on the extruder screw, wherein the controller installation, depending on the acquired information, controls the operation of the motor or of the further installation.

The invention relates to an extruder comprising an operative unit composed of a cylinder and at least one extruder screw which is removably accommodated therein, a motor and a gear unit which is separated from the motor via a clutch and which drives the extruder screw, wherein the extruder screw is releasably connected to the gear unit, and a controller installation which controls the operation of the motor or at least of a further installation which is provided, in particular, on the operative unit or is assigned to the operative unit.

As is known, extruders of this type serve for preparing compounds which, in the operative unit or the cylinder, respectively, are processed via one or more extruder screws rotating therein. In only an exemplary manner, mention may be made of plastic compounds which are melted and compounded in the extruder in order to be subsequently further processed, for example for forming plastic granules or in the context of injection-molding and for manufacturing components and similar. In an exemplary manner, mention should furthermore be made of pharmaceutical compounds which serve for the production of pharmaceuticals, for example in the form of tablets. Here too, the corresponding materials are processed and mixed etc. via the screws in the cylinder, in order to achieve the desired homogenous composition of the extruded product. In order to make this possible, one or more further installations, such as, for example, corresponding infeed installations, via which the materials to be processed are added in a metered manner, or heating installations, which serve for temperature-controlling the cylinder or the cylinder sections from which such a cylinder is typically assembled, or similar is/are provided on the operative unit or assigned to the operative unit, respectively. Also in the field of foodstuffs, corresponding compounds are often prepared using an extruder.

The drive of the one extruder screw or, in the case of a double-screw extruder, of both extruder screws, is obviously essential for the functioning of the extruder, since the torque of the screws and also the revolutions of the screws, both being relevant for the energy to be invested in the material to be processed, are set via the drive. This takes place via a motor and a corresponding reduction gear unit which is coupled to the screw or screws. The motor is coupled to the gear unit via a clutch, usually an overload clutch, wherein the overload clutch opens in the case of a corresponding given overload on the screw side and separates the gear unit and the motor. The in-principle construction and functioning of such an extruder is well known.

The extruder screw or screws is/are, of course, an essential component of an extruder. Depending on the material to be prepared and depending on the relevant operational objective, various types of screws are differentiated. So-called compact screws, which are made from one piece, are known. This means that the specific screw geometry is directly machined from a single material block. In addition, so-called screw sets in which a plurality of individual screw elements are successively pushed onto a screw shaft are known, wherein the screw elements and the screw shaft are interconnected in a rotationally fixed manner via corresponding toothings. Each screw element has a specific geometry. Depending on which type of screw is specifically introduced into the cylinder of the operative unit, various parameters, in particular with respect to motor control, have to be set by the operator, since higher torques can usually be transmitted via compact screws than via a screw set. Moreover, the individual extruder screws, with respect to their geometry, are also very specifically designed for a specific operative process; that is to say that a specific screw is assigned to a specific operative objective which, in turn, is assigned specific operating parameters which, for operating the extruder, have to be set by the operator of the controller installation. The corresponding setting of these parameters, whether type-related, geometry-related or screw-related, takes place prior to commencement of the operation per se, by manual programming of the controller installation by the operator, which is, of course, time consuming but, moreover, also prone to errors.

The invention is, therefore, based on the object of providing an extruder which, in comparison thereto, is improved.

In order to achieve this object it is provided according to the invention that at least one information element which identifies the extruder screw and which, during or after insertion of the extruder screw into the cylinder or connection to the gear unit, is automatically acquirable by means of a sensor element, is provided on the extruder screw, wherein the controller installation, depending on the acquired information, controls the operation of the motor or of the further installation.

According to the invention, the extruder is distinguished by an automatic acquisition of a screw-specific item of information by means of a suitable sensor element which communicates with the controller installation. To this end, a corresponding information element which carries the item of information in coded form is provided on the extruder screw. This information element is acquired by way of a corresponding sensor element and relayed to the controller installation which, based on these items of information, is capable of automatically setting at least part of the corresponding operating parameters, which have to be set in a screw-specific manner for controlling the motor and/or one or more further installations, and, based thereon, of performing corresponding control. Since this acquisition and parameter selection thus takes place automatically, the operator is no longer required to manually perform these settings.

Here, acquisition of information takes place automatically when the extruder screw is either introduced into the cylinder or when it is situated in the assembled position in the cylinder and/or is coupled to the gear unit. This ultimately depends on where the information element is positioned on the extruder screw and where the sensor element is positioned on the extruder frame itself.

The information element here may be or contain an item of information pertaining to whether it is a compact screw or an extruder screw having screw elements which are pushed onto the screw shaft. Via this item of information the type of screw is in each case communicated in coded form and is automatically identified by the controller installation. Depending on the identified type, said controller installation may, in particular, correspondingly control the operation of the motor, such that the screw-specific torque, which, as described, is higher in the case of compact screws than in the case of screw sets, is transmitted, and also the screw-specific motor revolutions are correspondingly set.

Additionally or alternatively, the information element may also contain an item of information pertaining to which type of operating method the extruder screw is assigned to. The type of screw is thus communicated by way of this item of information and acquired by the controller installation. As described, a screw is usually assigned to a specific method which, based on specific defined operating parameters of the extruder, serves for preparing a specific, defined compound. At times, a change of screw entails changing from a method which has been previously performed on the extruder to another method. The operator usually has to manually set the corresponding method parameters on the controller installation. According to the invention, this is no longer required, since the automatic identification of the screw takes place by the acquisition of the corresponding information and the corresponding operating parameters are automatically set by the controller installation. These operating parameters, too, may be the torque or the revolutions, but other operating parameters may also be set in this context; this will be discussed more in the following.

As mentioned, the controller installation controls the operation of the motor depending on the acquired information, in that the supplied torque and/or the motor revolutions is/are correspondingly set. This expediently takes place via a frequency inverter which is actuated via the controller installation. As described, the motor is coupled to the gear unit via a clutch. According to the invention, a switchable clutch, which, in its cut-out torque, is implemented in a correspondingly settable or switchable manner, and which is likewise, depending on the acquired information, controlled via the controller installation, is preferably employed as a clutch. If a higher torque is permitted and/or set by the controller installation, this modification of torque is also followed at the clutch by way of the switchable clutch provided according to the invention. This means that in the event of a higher torque being supplied by the motor, the clutch is also automatically correspondingly switched in order to transmit the higher torque. Since the clutch serves as a safety element which separates the gear unit and the motor if an excessive torque is applied on any side, which may happen in the case of an overload in the screw region, for example, a higher cut-out torque is also set via the controller installation when the motor is switched to supply a higher torque. The clutch thus follows with respect to the cut-out torque when the motor is correspondingly switched.

A pressure-impinged friction clutch is preferably provided as such a switchable clutch. This clutch has friction disks which are pressed together by means of air pressure. The slipping torque and thus the transmittable torque vary according to compression. By way of two sensors which are assigned to the two friction disks and/or the forward and rearward clutch part, any differential in the rotating speed of the two disks and thus the moment when slipping occurs can be acquired. As soon as a defined speed differential is acquired, the pressure is abruptly reduced, such that compression is abruptly reduced as a result, and the clutch opens. By means of such a pressure-impinged clutch, switching with respect to the transmittable torque and/or setting the safety cut-out torque is made possible in a simple manner.

As described, the specific screws are often assigned to specific operating methods, be it with respect to the materials to be processed, or be it with respect to the specific, section-wise operations in the cylinder, for example conveying the compound, kneading the components, and similar. These specific methods, in turn, are distinguished by the specific operating parameters of the individual relevant extruder components. According to the invention, after identification of the type of screw said extruder components are automatically set, to which end, depending on the acquired information, the controller installation, as a further installation, controls, for example, one or more heating installations which are provided on the operative unit and via which the cylinder can be heated. Additionally or alternatively, said controller installation may also control the operation of one or more infeed installations which are assigned to the operative unit and via which the material or various materials to be processed in the operative unit is/are supplied. Controlling the operation of a pumps which is downstream of the operative unit and via which the extruded compound is conveyed, and similar, is also conceivable. The controller installation now sets the specific method parameters which are assigned to the acquired screw, in order to control the motor and/or the corresponding further installations in a screw-specific and thus method-specific manner.

Of course, corresponding operating parameters and/or method-specific parameter spreadsheets or similar, which in turn are assigned to the screw-specific items of information, are filed in the controller installation. When acquiring an item of screw information, the controller installation now automatically selects the control parameter or control parameters which is/are assigned in a manner specific to the item of information and uploads those in order to control, based thereon, the subsequent operation, regardless of component.

Based on the acquired information, the controller installation is expediently also configured for storage of information relating to the screws. This makes possible documenting items of information relating to the screws in the controller installation itself. Since the specific screw is known on account of its identification, these items of information may now be specifically assigned to exactly this screw. Such an item of information to be stored may be, for example, the service time and/or the total service period of this specific screw in this specific extruder. By way of a comparison of experience values of the usual service life, for example, the procurement of spare parts for screw elements in the case of a screw set or any refurbishment of a compact screw can be acquired and coordinated in a timely fashion. In the pharma sector, assigning a specific screw to a specific lot which has been produced on the extruder may take place, for example, which is likewise expedient for reasons of documentation. The risk of an operating error can thus be minimized in principle.

Various designs are conceivable as information elements and assigned sensor elements. According to a first alternative of the invention, the information element may be a chip, in particular an RFID chip, and the sensor element may be a chip reader, in particular an RFID reader, which operates in a non-contacting manner. In this design, a transponder chip which can be read in a non-contacting manner via the corresponding chip reader is employed. Such a chip is of small overall size and may readily be disposed on the screw, for example be adhesively attached to the shaft or be embedded in a recess, etc. Acquisition is also readily possible over a certain distance, so that the chip information may even be read when the chip and the reader are positioned so as not to be directly opposite one another.

A particular advantage in the use of such a transponder chip, in particular in the form of an RFID chip, lies in that this chip may simultaneously also be used as a storage element. This offers the particularly expedient possibility, controlled via the controller installation by way of the sensor element, of storing items of information, in particular operating parameters for the screw-shaft specific operation of the extruder, or of a further installation, or the service life of the extruder screw, in the chip, in particular in the RFID chip. This means that the chip serves as an information carrier for additional information beyond the items of information relating purely to screw identification. On said chip, corresponding operating parameters, i.e. method parameters to be set, which are required for the screw-shaft specific extruder operation or the corresponding control of the further installations (infeed installations, heating elements, etc.) may be stored. This means that each screw ultimately carries with it the corresponding operating parameters and/or items of information relating to the method. If the extruder screw is thus installed in another extruder, the screw-specific operating parameters can be automatically read and correspondingly set by way of the controller installation. Said operating parameters, therefore, do not necessarily have to be kept so as to be available in the controller installation. Alternatively or additionally, items of information which serve, for example, for documenting the running time of screws, may also be filed in the chip. These items of information may, when required, also be read on the dismounted extruder screw, for example in a screw store where the screws are kept in reserve. It may now be acquired at this point how long a specific screw has been in operation and whether any maintenance work has to be performed, etc.

As an alternative to using a chip having an assigned reader, an information element may also be implemented in the form of a metallic element or of a magnetic element, and the sensor element may be implemented as an eddy current sensor. The metallic element or the magnetic element is also fixedly and unreleasably connected to the screw. If this metallic element or the magnetic element is placed or moved, respectively, into the proximity of the eddy current sensor, induction of an eddy current in the sensor occurs. The height of the induced current, in turn, specifically depends on the metallic element or the magnetic element. By way of the height of the induced current, coding of the screw can thus be achieved, since the various installable extruder screws are assigned specific metallic elements or magnetic elements. It is also conceivable to dispose a plurality of such magnetic elements or metallic elements in a distributed manner on the circumference, such that screw rotation leads to a defined pattern of induction current, which in turn is coding for an item of information. In this case, acquisition of information would be acquired particularly in the case of screw rotation taking place in an experimental operation. Here, the metallic element or magnetic element would be an element which is disposed on the screw and does not extend around the circumference of the screw. Alternatively, it is also conceivable for such an element to be implemented in the form of a ring which is disposed on the screw. Upon insertion of the screw, this ring, irrespective of the angular position of the screw, would thus be inevitably guided past the eddy current sensor, on account of which the eddy current is induced. The metallic element is expediently of a metal alloy, wherein the corresponding metallic elements assigned to the individual screws differ in their respective metal alloys, which leads to induction currents of different heights. In the case of a magnetic element, a permanently magnetic material is expediently used.

A third alternative with respect to the design of an information element provides that an optically scannable code, in particular in the form of a bar code, is used, and that a code reader, in particular a bar-code reader, is used as a sensor element. Here, too, non-contacting scanning takes place in an optical manner. The bar code here may run in the circumferential direction, for example, such that said bar code is acquired in the context of a first screw rotation. Alternatively, it would also be conceivable for the bar code to be disposed in an encircling manner in the longitudinal direction of the screw, so to speak, such that said bar code, irrespective of the position of the screw, is inevitably acquired when being moved past the code reader during insertion. As an alternative to such a bar code, of course another, for example reflective, code by way of correspondingly disposed reflective patterns or other shape patterns or color patterns and similar may be used.

The code, in particular the bar code, here may be directly incorporated in the screw material. It is also conceivable, however, for said bar code to be disposed in the form of a code carrier on the extruder screw.

With respect to the positioning of the information element on the extruder screw and the positioning of the sensor element, various designs are conceivable. The information element itself is expediently disposed in the region of the end of the extruder screw that is directly, or via a collar coupling, connected to the gear unit, since a somewhat longer shaft portion or shaft end portion on which the information element can be readily positioned is located there. The sensor element may be positioned on various points on the extruder frame. It is conceivable for said sensor element, in relation to the mounting position of the extruder screw, to be disposed close to the gear unit, such that the information element lies in the acquisition region of the sensor element when the screw is mounted. Alternatively, the sensor element could also be positioned at the discharge end of the operative unit, such that the information element is inevitably moved past the sensor element when the extruder screw is inserted.

Further advantages, features and details of the invention are derived from the exemplary embodiment, which is described in the following, and by means of the drawings. In the drawings:

FIG. 1 shows an in-principle illustration of an extruder according to the invention,

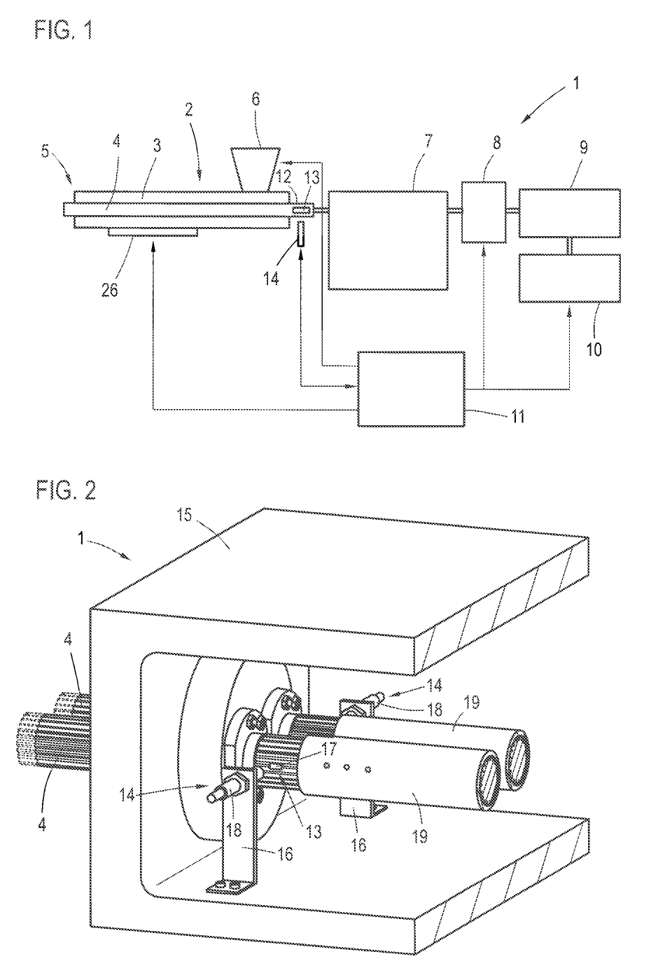

FIG. 2 shows an enlarged detailed view of the region of the extruder screw connection to the gear unit, having, as information carriers, chips which are disposed on the extruder screws and, as sensor elements, chip readers which are assigned to the former,

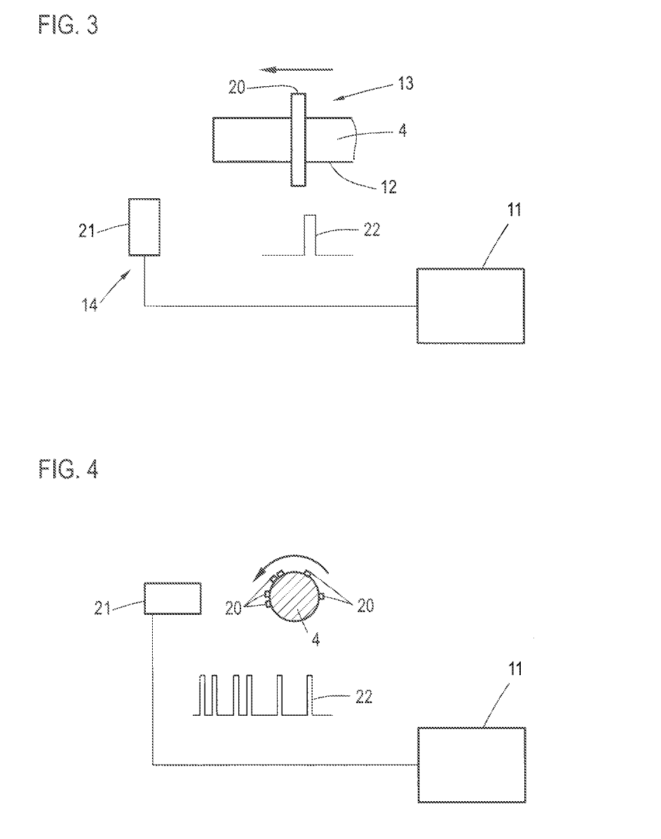

FIG. 3 shows an in-principle illustration of a design having an information element in the form of a ring and a sensor element in the form of an eddy current sensor,

FIG. 4 shows an in-principle illustration of a design having a plurality of metallic elements or magnetic elements which are distributed around the circumference and a sensor element in the form of an eddy current sensor,

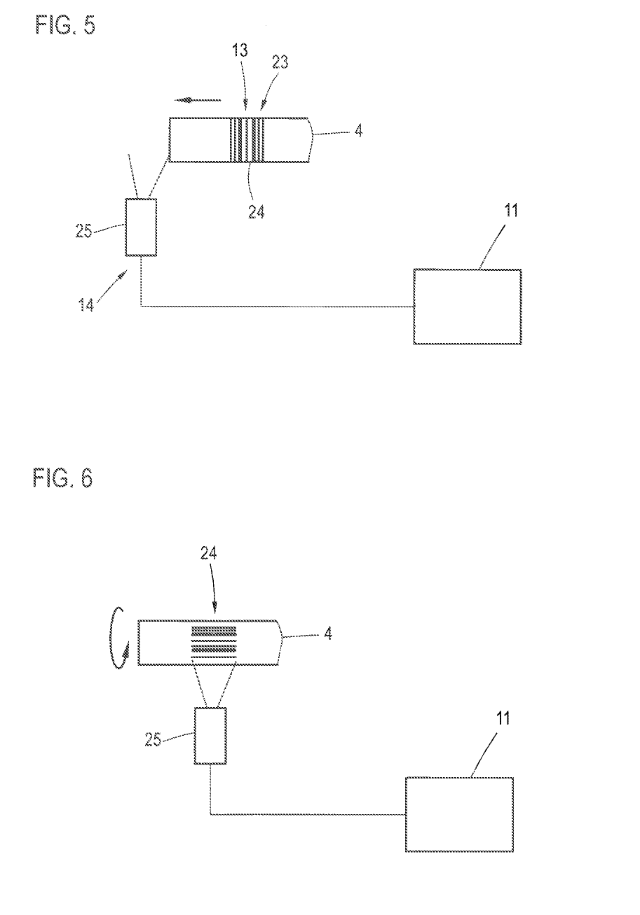

FIG. 5 shows an in-principle illustration of a design having an information element in the form of a bar code and a sensor element designed as a bar-code reader, and

FIG. 6 shows an in-principle illustration of a design having a circumferentially disposed information element in the form of a bar code, and a bar-code reader.

FIG. 1, in the form of an in-principle illustration, shows an extruder 1 according to the invention, comprising an operative unit 2 having a cylinder 3 which, as is mostly usual, is composed of a multiplicity of individual cylinder segments which are lined up in sequence and interconnected. At least one extruder screw 4, which is inserted from the discharge end 5 of the operative unit 2, is removably disposed in the cylinder 3 (shown in a highlighted manner here). Of course, in the case of a double-screw extruder, also two such extruder screws 4 may be inserted into the cylinder bore which, in that case, is implemented as a figure-eight bore.

Furthermore, additional installations in the form of an infeed installation 6 and of a heating installation 26 are disposed on the operative unit 2 or assigned thereto, respectively. The material or materials to be processed are loaded via the infeed installation 6 (of course, a plurality of such infeed installations 6 may also be provided). The cylinder 3 may be temperature-controlled by way of the heating installation 26 (or of a plurality of separate heating installations).

The extruder 1 furthermore comprises a gear unit 7 which is coupled to a motor 9 via a switchable clutch 8. Said motor 9 is actuated by way of a frequency inverter 10. The gear unit 7 itself is connected to the extruder screw or extruder screws 4 in a rotationally fixed manner by way of a collar coupling, for example, or similar.

A controller installation 11 which, in the example shown, controls the inverter 10 and, via the latter, the operation of the motor 9 with respect to the torque generated or supplied, respectively, by the motor 9 and the revolutions, is furthermore provided. The controller installation 11 furthermore controls the switchable clutch 8, which is preferably a pressure-impinged friction clutch, which can be actively switched. The air pressure by way of which the friction-clutch disks are compressed is controlled via the controller installation 11. Depending on how high the compression of the disks is, a variably high torque may be transmitted, or a variably high cut-out torque in the case of overload may be set.

As is further indicated by way of illustrated arrows, the controller installation 11 also controls the operation of the infeed installation 6, this is to say the metering of material and also the operation of the heating installation 26.

An information element 13 is furthermore fixedly disposed on the shaft 12 of the extruder screw 4 shown here. This information element 13 contains one or more items of information pertaining to which type the extruder screw 4 is, that is to say whether it is a compact screw or a screw set, that is to say a screw having a screw shaft with screw elements pushed thereon. The one or more items of information may also contain items of information pertaining to the type of the operating method which this specific extruder screw is assigned to or which is to be carried out with said screw, respectively. These items of information relating to the type of the operating method may also be provided in the form of operating parameters which are filed directly on the information element and which are to be set and/or controlled by the controller installation 11 for operating the components controlled by it.

Furthermore provided is a sensor element 14 which is capable of acquiring the items of information which are filed in a coded manner on or in the information element 13. The sensor element 14 is, of course, correspondingly designed depending on the type of information element. Said sensor element 14 communicates at least unidirectionally with the controller installation 11, that is to say that the items of information acquired by the sensor element 14 are relayed to the controller installation 11. It is, however, also conceivable for a bidirectional communication to be provided (as is illustrated by the double arrow). In this case, the sensor element 14 would be configured for storing information on the information element 13 itself, the latter being then simultaneously implemented as a writable storage element. This makes it possible for items of information which have been harvested by the controller installation, such as items of information pertaining to the service period of the extruder screw 4 and similar, but also corresponding operating parameters and similar, to be directly stored in the information element 13, such that these items of information can be read again at another point, for example when installing the extruder screw 4 in another extruder.

The controller installation 11, after automatically acquiring the items of information which are carried in coded form by the information element 13, is now capable of implementing the corresponding items of information or of setting or processing, respectively, the corresponding control parameters by way of the sensor element 14. If the item of information indicates, for example, that the extruder screw 4 is a compact screw, the controller installation 11 uploads a corresponding set of control data via which the inverter 10 and thus the motor 9 are actuated such that a higher torque is generated, since compact screws can be operated at higher torques. The switchable clutch 8 is simultaneously actuated in a corresponding manner, in order to install a higher cut-out torque, that is to say an overload torque which, when applied, causes the clutch 8 to automatically open. Of course, corresponding revolution values which are to be adhered to in a screw-specific manner may also be set.

If the coded items of information of the information element 13 indicate specific operating parameters which define a specific method assigned to the screw, the latter are automatically uploaded and/or processed by the controller installation 11. By way of said operating parameters, in addition to the parameters of torque and revolutions, corresponding control parameters pertaining to the infeed installation 6 and to the heating installation 26 also form a basis for the controller.

Of course, in the case of a double-screw extruder, each extruder screw has a corresponding information element 13 which is assigned a corresponding sensor element 14. Since both screws are assigned to one and the same method and ultimately also have to be of the same type, the two sensor elements 14 thus have to read identical items of information. Accordingly, two sets of information, which have to be identical in as far as items of information pertaining to the type of screw and to the assigned types of methods and/or the operating parameters are contained, form a basis for the controller installation 11. Only the specific identification information of the screws differs. By means of these two sets of information data, the controller installation 11 may now perform a plausibility check to verify, whether really two screws of the same type have been installed. By way of said plausibility check a redundancy check with respect to the correctly used screws 4 may thus take place. Should there be any discrepancies in the information content, the controller installation 11 may emit a corresponding alarm signal or similar, and operation may be blocked.

In the form of an enlarged in-principle illustration, FIG. 2 shows a detail of the extruder 1 which here is implemented as a double-screw extruder having two extruder screws 4. An extruder frame 15, on which on both sides in each case one sensor element 14 is disposed by way of corresponding supports 16, is shown. An information element 13, which in the example shown is assumed to be a chip, in particular an RFID chip 17, is disposed on each extruder screw 4. Each sensor element 14 is thus implemented as a chip reader 18 which can read in a non-contacting manner the items of information stored in the respective chip 17. The two extruder screws 4, in the region of their shaft-side toothings, are connected via corresponding collar couplings 19 with the gear unit 7, which is not shown here.

Such an RFID chip 17 may simultaneously also be used as a storage chip. This means that the respective chip reader 18 may also be used for writing new items of information to the respective RFID chip 17. These remanently stored items of information “migrate” so to speak along with the respective extruder screw 4 and may be read elsewhere, for example in another extruder.

FIG. 3 shows an in-principle illustration of a further design of an information element 13 and of a sensor element 14. The information element 13 here is implemented as a metallic element 20 in the form of a ring which has been heat-shrunk onto the screw shaft 12. The sensor element 14 is implemented as an eddy current sensor 21. If the metallic element 20 is moved past the eddy current sensor 21 during insertion of the extruder screw 4, as is illustrated by the arrow, an eddy current, which is illustrated by way of the symbol 22, is induced in the eddy current sensor 21. This induced eddy current and/or the amplitude of the signal, as a coded item of information, are/is specific to the specific extruder screw 4. This corresponding information signal is relayed to the controller installation 11 for further processing. Even this one signal, that is to say this one item of information, may be assigned various information content by the controller installation 11. Said one signal may be assigned an item of information pertaining to the type of screw (compact screw/screw set) and also corresponding method information. This is because the specific height of the induced current is unequivocal for a specific screw, since said current can be set at will, so to speak, depending on the design of the annular metallic element 20 and/or the material selection of the latter, such that an unequivocal assignment of the signal to a specific screw is possible.

FIG. 4 likewise shows a sensor installation which is based on the eddy current principle. However, here a plurality of individual metallic elements 20 having variable spacing are provided on the circumference of the extruder screw 4 and/or the shaft 12. If the assembled extruder screw 4 is rotated, the individual metallic elements 20 are moved past the eddy current sensor 21. The inevitable result is an individually profiled signal and/or eddy current profile, such as illustrated by the signal 22, which, in turn, is relayed to the controller installation 11. Individual items of information which may be read and implemented by the controller installation may be transmitted via the respective signal stroke and also the specific signal profile.

As an alternative to the use of metallic elements 20, it is, of course, also conceivable for corresponding magnetic elements to be disposed, for example in the form of permanent magnets. By way of these, corresponding eddy currents may also be induced in the eddy current sensor 21.

FIG. 5 shows a design of a sensor installation in which a code 23, which runs in the longitudinal direction on the screw shaft 4 and is an optically scannable code, here in the form of a bar code 24, is disposed as an information element 13 on said screw shaft 4. Here, the sensor element 14 is implemented as a code reader and/or bar-code reader 25. If the extruder screw 4 is inserted in the longitudinal direction, the bar code 24 moves through the acquisition region of the bar-code reader 25 and may be acquired. In turn, the information is relayed to the controller installation 11 which subsequently uploads the corresponding operating parameters which are assigned to the item of information or directly implements the transmitted operating parameters.

Finally, FIG. 6 shows a comparison design for the sensor installation; however, here the bar code 24 is attached in the circumferential direction. When the screw 4 is assembled, said bar code 24 is located in the acquisition region of the bar-code reader 25 and is acquired in the case of a rotation of the screw.

The corresponding information elements 13, irrespective of type, are, of course, fixedly and unreleasably connected to the respective extruder screw 4. In the case of an RFID chip 17, this chip can be inserted into a corresponding recess on the shaft and be sealed therein, or, since it is of very small overall size, may be attached onto the surface, etc. The corresponding metallic elements or magnetic elements 20 may likewise be attached onto the surface or may also be incorporated in depressions. The respective code 23 and/or bar code 24 may be directly incorporated in the screw material and thus be implemented as an elevation relief or elevation profile. Disposing a separate information carrier is, however, also conceivable.

1. Extruder comprising an operative unit having a cylinder and at least one extruder screw which is removably accommodated therein, a motor and a gear unit which is separated from the motor via a clutch and which drives the extruder screw, wherein the extruder screw is releasably connected to the gear unit, and a controller installation which controls the operation of the motor or at least of a further installation which is provided, in particular, on the operative unit or is assigned to the operative unit, wherein at least one information element which identifies the extruder screw and which, during or after insertion of the extruder screw into the cylinder or connection to the gear unit, is automatically acquirable by means of a sensor element, is provided on the extruder screw, wherein the controller installation, depending on the acquired information, controls the operation of the motor or of the further installation.

2. Extruder according to claim 1, wherein the information element contains an item of information pertaining to whether it is a compact screw or an extruder screw having screw elements which are pushed onto a screw shaft,

3. Extruder according to claim 1, wherein the information element contains an item of information pertaining to which type of operating method the extruder screw is assigned to

4. Extruder according to claim 1, wherein the controller installation, depending on the acquired information, controls a frequency inverter for setting a torque which is supplied by the motor, and/or the motor revolutions.

5. Extruder according to claim 4, wherein the controller installation controls the clutch, which is implemented as a clutch which is switchable at the cut-out torque, depending on the acquired information.

6. Extruder according to claim 5, wherein the clutch is a pressure-impinged friction clutch.

7. Extruder according to claim 1, wherein, depending on the acquired information, the controller installation, as a further installation, controls one or more heating installations which are provided on the operative unit, the operation of one or more infeed installations which are disposed on the operative unit, or the operation of a pump which is downstream of the operative unit.

8. Extruder according to claim 1, wherein, based on the acquired information, the controller installation is configured for storage of information relating to the screws.

9. Extruder according to claim 1, wherein the information element is a chip, in particular an RFID chip, and the sensor element is a chip reader, in particular an RFID reader, which operates in a non-contacting manner.

10. Extruder according to claim 9, wherein, controlled via the controller installation by way of the sensor element, items of information, in particular operating parameters for the screw-shaft specific operation of the extruder, or of a further installation, or the service life of the extruder screw, can be stored in the chip, in particular the RFID chip.

11. Extruder according to claim 1, wherein the information element is a metallic element or a magnetic element, and the sensor element is an eddy current sensor.

12. Extruder according to claim 11, wherein the metallic element or magnetic element is an element which is disposed on the extruder screw and does not extend around the circumference of the screw, or a ring of a metal alloy or of a permanently magnetic material that is disposed on the extruder screw.

13. Extruder according to claim 1, wherein, the information element is an optically scannable code, in particular a bar code, and the sensor element is a code reader, in particular a bar-code reader.

14. Extruder according to claim 13, wherein the code, in particular the bar code, is directly incorporated in the screw material or is attached in the form of a code carrier on the extruder screw.

15. Extruder according to claim 1, wherein, the information element is disposed in the region of the end of the extruder screw that is directly, or via a collar coupling, connected to the gear unit, and the sensor element, in an extruder frame, is provided adjacent to the region in which the information element is disposed, or on the discharge end of the operative unit.
